(19) United States
(12) Patent Application Publication
(10) Pub. No.: US 2026/0252838 A1
(43) Pub. Date: Aug. 27, 2026

(54) PAYMENT CARD WITH DNA PROCESSING AND BIOMETRIC AUTHENTICATION CAPABILITY AND METHODS FOR MANUFACTURING SAME

(71) Applicant: SPARX NOVATE, LLC, NEW YORK, NY (US)

(72) Inventor: ISAAC DANIEL, PARKLAND, FL (US)

(73) Assignee: SPARX NOVATE, LLC, NEW YORK, NY (US)

(21) Appl. No.: 19/551,915

(22) Filed: Feb. 27, 2026

Related U.S. Application Data
(60) Provisional application No. 63/764,125, filed on Feb. 27, 2025.

(51) Int. Cl. G06K 19/07; G06F 21/32; G06K 19/077; G06Q 20/34

(52) U.S. Cl. CPC G06K 19/0718; G06F 21/32; G06K 19/077; G06Q 20/341; G06Q 20/357

(57) ABSTRACT

A payment card configured for financial transaction operations, DNA processing and biometric authentication, along with computer-implemented methods and computer programmable product for enabling operation of same. The contemplated payment card also includes a microchip having one or more processors, memory, a DNA processing module configured to receive DNA samples for processing, a biometric sensor module configured to receive biometric data from a cardholder, and a transceiver module for communication with external networks.

### CROSS-REFERENCE TO RELATED APPLICATIONS

This application claims priority to and the benefit of U.S. Provisional Patent Application No. 63/764,125, filed Feb. 27, 2025, entitled “Payment Card With DNA Processing and Biometric Authentication Capability and Methods for Manufacturing Same”. The entire disclosure of the previously filed provisional application is hereby incorporated by reference in its entirety.

### FIELD OF THE INVENTION

The present invention is related to computer implemented methods, processes, computer program product, and devices directed to: a payment card having payment processing capabilities and being integrated with DNA processing, and biometric authentication to enhance security during financial transactions. The present invention is also related to: the payment card's transmissive capabilities to biometric sensor(s), operation of, and methods for manufacturing, said payment card.

### BACKGROUND OF THE INVENTION

In the current financial landscape, payment cards primarily utilize PINs, signatures, or magnetic strips for authentication. However, these methods are increasingly vulnerable to theft, fraud, and identity theft.

Existing biometric systems often require separate devices or applications, complicating user experience and security. With advancements in technology, a need has arisen for more secure methods of verifying the identity of cardholders. There is a growing demand for more secure payment mechanisms due to increasing incidences of fraud. Moreover, advancements in biometric technologies and rising consumer awareness of data security amplify the market potential for this integrated payment solution.

Aspects of embodiments of the present invention contemplate the integration of DNA processing and biometric verification directly into a payment card. As a result, aspects of embodiments of the present invention provide a streamlined solution to enhance security and reduce fraud. By leveraging biological data, aspects of embodiments of the present invention aim to provide a foolproof mechanism for identity verification.

Aspects of embodiments of the present invention seek to significantly mitigate the risks associated with identity theft and fraud in payment transactions by providing a dual-layered security system that combines DNA analysis and biometric verification.

Aspects of embodiments of the present invention contemplate incorporation and implementation of a confirmation process will be implemented where users must provide explicit consent for the collection and storage of their DNA data, along with clear disclosures regarding how this data will be used, stored, and protected. The contemplated technology is highly scalable. Once the manufacturing process is established, the card can be adapted for various markets and applications, including healthcare and security access systems.

Utilizing DNA for verification ensures a high level of accuracy and uniqueness. However, it also mandates strict adherence to data protection laws, as DNA data is sensitive and personal. Aspects of embodiment of the present invention also seek to overcome consumer resistance to blood sample collection, ensuring the reliability of new biometric technology integration, while addressing regulatory compliance effectively.

### Potential Applications and Market Implications

The contemplated invention has numerous potential applications, including:

Financial Transactions: The primary application will be in secure payment processing, drastically reducing the risk of fraud and identity theft.

Healthcare: The DNA analysis capabilities could be utilized in medical settings, providing healthcare professionals with immediate genetic information relevant to treatment.

Access Control: Beyond payments, this technology could be applied to secure access systems (e.g., buildings, devices) where identity verification is critical.

Personal Identification: The card could serve as a comprehensive form of identification that can replace multiple identification methods (e.g., ID cards, healthcare cards).

Market Trends: The demand for biometric security solutions is growing due to increasing concerns over fraud and data breaches. This innovation positions itself well within current market trends favoring heightened security technologies.

### Regulatory Compliance And Privacy Considerations

Regulatory Compliance: The invention must comply with regulations set by financial authorities for payment systems as well as healthcare regulations for devices that involve blood sample collection. It will also need to meet standards set by organizations such as the FDA (in the US) for medical devices.

Privacy Considerations: Given the sensitivity of genetic data, strict measures will be required to ensure personal data is protected. The card should incorporate encryption methods for data transmission and storage to prevent unauthorized access to biometric and genetic information. Users will need to consent to the collection and use of their DNA data, with clear communication about how that data will be stored and utilized.

User Interaction and Usability

Ease of Use: The card will be designed for easy handling and operation, allowing users to collect a blood sample with minimal discomfort. Clear instructions will be provided for using the card, including how to collect the sample and initiate the verification process.

Sample Collection: Upon activating the needle mechanism, the user will feel a slight pinch to collect a small blood sample, which is then processed immediately. A built-in comfort mechanism will reduce discomfort during the needle insertion.

Verification Process: Once the blood sample is processed and DNA analyzed, the biometric verification will occur seamlessly. Users will receive visual or audible feedback regarding the success of the verification process.

Integration with Point-of-Sale Systems: The card is designed to function with existing point-of-sale systems, ensuring compatibility and ease of use in retail environments. The results of the biometric and DNA processing will be sent to the payment system for authentication.

Aspects of embodiments of the present invention represent a significant advancement in payment technology, combining biometric security with DNA processing to provide an unparalleled level of identity verification. The integration of these technologies within a single, user-friendly card format addresses the pressing concerns of fraud and identity theft faced in today's financial landscape.

By aligning with current market demands for secure, efficient payment solutions and adhering to necessary regulatory standards, this invention not only enhances transaction security but also opens new avenues for applications in healthcare, personal identification, and access control.

The design prioritizes user experience, ensuring that the collection of biomaterials and the verification process are as seamless as possible, thereby encouraging widespread acceptance and usability.

Aspects of embodiments of the present invention ensure that only the legitimate holder can use it during transactions, significantly decreasing instances of identity theft and fraud.

### SUMMARY OF THE INVENTION

Aspects of embodiments of the present invention contemplate a payment card configured for financial transaction operations, DNA processing and biometric authentication, where the payment card includes: a microchip comprising at least one processor configured to perform a predefined set of basic operations in response to receiving a corresponding basic computer executable instruction selected from a predefined native instruction set of codes; memory; a DNA processing module; a biometric sensor module; and a transceiver module. In an aspect of an embodiment of the present invention, the embedded microchip will contain secure payment processing algorithms, encryption protocols, and/or computer code to protect user information. In another aspect of an embodiment of the present invention, the DNA processing module may include enhanced data analytic capabilities and thus may be configured to process genetic information, be integrated with mobile payment systems, and be configured to seamlessly interact and/or be integrated into health monitoring devices and/or systems.

In an aspect of an embodiment of the present invention, the at least one processor of the payment card may be in communication with any one or more of: the memory, the DNA processing module, the biometric sensor module, the transceiver module. Aspects of embodiments of the present invention contemplate use of unique synthetic wire that enables transmission of DNA results linked to the fingerprint or vein scan to the processing area for determination as to whether there is a match. In another aspect of an embodiment of the present invention, the payment card may be integrated with mobile payment systems, and be configured to seamlessly interact and/or be integrated into health monitoring devices and/or systems.

In an aspect of an embodiment of the present invention, the DNA processing module of the payment card may include a needle mechanism, where the needle mechanism may be configured to puncture a cardholder's skin to collect a minimal blood sample, a processing area, where the processing area may be a chamber or compartment within the DNA processing module where DNA may be extracted and analyzed, and a DNA analysis module, where the DNA analysis module may be configured to receive and process the collected blood sample for DNA analysis and identification confirmation of the cardholder. In an aspect of an embodiment of the present invention, the needle mechanism may include a small, safe needle that punctures the skin to collect a minimal blood sample. In another aspect of an embodiment of the present invention, the processing area chamber may include microfluidic technology for efficient/improved sample handling and analysis efficiency. In another aspect of an embodiment of the present invention, the DNA processing module may process the DNA sample from the blood sample to confirm the identity of the cardholder within seconds, generating a result that is relayed to the microchip. In a further aspect of an embodiment of the present invention the DNA processing module may include secure snap or slide covers to maintain the integrity of the area after a sample is taken. Additionally, the DNA processing module may include tiny outlets designed for future programmable genetic diagnostics based on the captured DNA.

In a further aspect of an embodiment of the present invention, the DNA processing module may be equipped with a microchip module for further processing needed by the DNA processing module or to conduct the DNA processing module processing operations.

In a further aspect of an embodiment of the present invention, the needle mechanism may be configured to minimize discomfort and provide a safe and effective method for the collection of a small blood or tissue sample for DNA analysis.

In a further aspect of an embodiment of the present invention, the snap cover may be a mechanism that secures the DNA processing area (or portions of same) after the needle mechanism has been used, thereby preventing bleeding and reducing the risk of infection. Both the needle mechanism and the snap cover mechanism may be made from biocompatible materials to ensure safety when they come in contact with skin.

The design of the DNA processing area (or portions of same) allows for easy sterilization to prevent contamination before use. In an aspect of an embodiment of the present invention, the DNA processing module may include a sterilization component that sterilizes the DNA processing area (or portions of same) before or after collection of the DNA, blood, or tissue sample.

In an aspect of an embodiment of the present invention, the biometric sensor module of the payment card may include: a combination fingerprint scanner and vein reader, where the combination fingerprint scanner and vein reader may be configured to either read the cardholder's fingerprint or scan the cardholder's subcutaneous vein pattern(s), a verification module, where the verification module may be configured to compare the cardholder's biometric data and DNA results to confirm identity. In an aspect of an embodiment of the present invention, the combination fingerprint scanner and vein reader may read the fingerprint or vein pattern. This data may then be matched against the DNA profile stored securely on the payment card's memory. In an aspect of an embodiment of the present invention, the verification module, upon receipt of the DNA results and biometric data, will engage in the verification process in which the cardholder's biometric data and DNA results are compared to confirm identity. If both match, the payment can proceed.

In an aspect of an embodiment of the present invention, the transceiver module of the payment card may include a radio transmitter, a receiver, and at least one processor configured to: secure a high-speed link between the DNA processing module and the microchip and integrate with existing payment networks for cardholder identity verification and transaction authorization. In an aspect of an embodiment of the present invention, the transceiver module operates a transmission system which includes the establishment and maintenance of high-speed link that ensures secure communication between the DNA processing unit/module and the payment card's microchip and/or external payment systems. In an aspect of an embodiment of the present invention, the transceiver module will also integrate the payment card with existing payment networks to immediately verify identity and authorize transactions based on the collected data. The transceiver module may also be enabled to relay identity confirmation during payment transactions.

In an aspect of an embodiment of the present invention, the payment card may include durable shielding, where the shielding protects electronic components of the payment card. In another aspect of an embodiment of the present invention, the payment card may also include a tamper proof feature to protect against unauthorized access or alterations.

In an aspect of an embodiment of the present invention, the payment card may be made of biocompatible materials, which may include materials that prevent adverse reactions when in contact with skin. The payment card may also include durable shielding using additional materials to protect the payment card's electronic components from physical damage and environmental factors.

In an aspect of an embodiment of the present invention, the payment card may be made of a flexible substrate which may be constructed from durable materials that withstand wear and tear while accommodating the embedded technology for DNA processing and payment functions.

In an aspect of an embodiment of the present invention, any one or more of: the DNA processing module, the biometric sensor module, may include a sub-processor for processing computer-implemented analyses and operations, where the sub-processor may be respectively resident on any one or more of: the DNA processing module, the biometric sensor module.

In an aspect of an embodiment of the present invention, the payment card may include a backup identification module for operation when any one or more of: said biometric sensor module, DNA processing module fails, where the backup identification module may be in communication with any one or more of: the microchip, the biometric processing module, the DNA processing module; where the backup identification module may include at least one processor. In another aspect of an embodiment of the present invention, the backup identification module may involve use of pins, traditional signatures, or other means of identification.

Another aspect of an embodiment of the present invention contemplates a computer-implemented method for operation of a payment card configured for financial transaction operations, DNA processing and biometric authentication, the method comprising executing on at least one processor configured to perform a predefined set of basic operations in response to receiving a corresponding basic instruction selected from a predefined native instruction set of code, the at least one processor being part of a microchip of the payment card, the steps of: operation of the at least one processor in conjunction with memory on the payment card; operation of a DNA processing module; operation of a biometric sensor module; and operation of a transceiver module.

In another aspect of an embodiment of the present invention, the computer implemented method of the payment card may include operation of the at least one processor of the microchip in communication with any one or more of: the memory of the payment card, the DNA processing module, the biometric sensor module, the transceiver module.

In another aspect of an embodiment of the present invention, the computer implemented operation of the DNA processing module may include: collection of a minimal blood sample by a needle mechanism of the DNA processing module, extraction and analysis of DNA from the blood sample by a processing area of the DNA processing module, and identification confirmation by the DNA processing module.

In another aspect of an embodiment of the present invention, the computer implemented operation of the biometric sensor module may include: reading a cardholder's fingerprint, scanning the cardholder's subcutaneous vein pattern(s) by a combination fingerprint scanner and vein reader of the biometric sensor module, and identity verification by a verification module of the biometric sensor module, where the verification module may be configured to compare the cardholder's biometric data and DNA results to confirm identity. The biometric sensor module operates with the DNA processing module to enhance authentication accuracy.

In another aspect of an embodiment of the present invention, the computer implemented operation of the transceiver module may include: securing a high-speed link between the DNA processing module and the microchip, and integrating the payment card with existing payment networks for cardholder identity verification and transaction authorization, where the integration may be done by at least one processor of the transceiver module using any one or more of: a radio transmitter, a receiver of the transceiver module.

In another aspect of an embodiment of the present invention, the computer implemented operation of any one or more of: the DNA processing module, the biometric sensor module, may include processing computer-implemented analyses and operations by a sub-processor respectively resident on any one or more of: the DNA processing module, the biometric sensor module.

In another aspect of an embodiment of the present invention, the computer implemented operation of the microchip may include: implementation and operation of encryption protocols to securely store and transmit sensitive data related to a cardholder's DNA and biometric information; implementation and operation of a feedback system that provides a cardholder with visual and/or auditory confirmation of successful identity verification; and implementation and operation of a digital tamper proof feature to protect against unauthorized access and/or data alterations.

In another aspect of an embodiment of the present invention, the computer implemented operation of the payment card may include: operation of a backup identification module for operation when any one or more of: the biometric sensor module, DNA processing module fails, where the backup identification module is in communication with any one or more of: the microchip, the biometric processing module, the DNA processing module; where the backup identification module may include at least one processor.

A further aspect of an embodiment of the present invention contemplates a computer program product comprising a non-transitory computer readable medium having control logic stored therein for causing one or more computer processors, resident on a microchip, and configured to perform a predefined set of basic operations in response to receiving a corresponding basic instruction selected from a predefined native instruction set of code to enable operation of a payment card, the control logic comprising computer readable code for: operation of the at least one processor in conjunction with memory on the payment card; operation of a DNA processing module; operation of a biometric sensor module; and operation of a transceiver module.

In a further aspect of an embodiment of the present invention, the computer program product may include computer code for operation of the at least one processor of the microchip in communication with any one or more of: memory of the payment card, the DNA processing module, the biometric sensor module, the transceiver module.

In a further aspect of an embodiment of the present invention, the computer code for operation of the DNA processing module may include: computer code for collection of a minimal blood sample by a needle mechanism of the DNA processing module, computer code for extraction and analysis of DNA from the blood sample by a processing area of the DNA processing module, and computer code for identification confirmation by the DNA processing module.

In a further aspect of an embodiment of the present invention, the computer code for operation of the biometric sensor module may include: computer code for reading a cardholder's fingerprint, scanning the cardholder's subcutaneous vein pattern(s) by a combination fingerprint scanner and vein reader of the biometric sensor module, and computer code for identity verification by a verification module of the biometric sensor module, where operation of the verification module may include computer code configured to compare the cardholder's biometric data and DNA results to confirm identity.

In a further aspect of an embodiment of the present invention, the computer code for operation of the transceiver module may include: computer code for securing a high-speed link between the DNA processing module and the microchip, computer code for integrating the payment card with existing payment networks for cardholder identity verification and computer code for transaction authorization, where the integration may be done by at least one processor of the transceiver module using any one or more of: a radio transmitter, a receiver of the transceiver module.

In a further aspect of an embodiment of the present invention, the computer code for operation of the computer code for operation of any one or more of: the DNA processing module, the biometric sensor module, may include computer code for processing computer-implemented analyses and operations by a sub-processor respectively resident on any one or more of: the DNA processing module, the biometric sensor module.

In a further aspect of an embodiment of the present invention, the computer code for operation of the microchip may include: computer code for implementation and operation of encryption protocols to securely store and transmit sensitive data related to a cardholder's DNA and biometric information; computer code for implementation and operation of a feedback system that provides a cardholder with visual and/or auditory confirmation of successful identity verification; and computer code for implementation and operation of a digital tamper proof feature to protect against unauthorized access and/or data alterations.

In a further aspect of an embodiment of the present invention, the computer code for operation of the payment card comprises: computer code for operation of a backup identification module for operation when any one or more of: the biometric sensor module, DNA processing module fails, where the backup identification module is in communication with any one or more of: the microchip, the biometric processing module, the DNA processing module; where the backup identification module comprises at least one processor.

Aspects of embodiments of the present invention contemplate the use of computer implemented methods, processes, systems, computer program product (comprising a computer usable medium having computer executable instructions stored therein for causing a computer processor to perform certain tasks), and devices directed to the full operation and functionality of a payment card as disclosed in the accompanying disclosure and Drawings being filed herein.

Aspects of embodiments of the present invention contemplate the use of modules in implementation of the process(es) outlined herein and operation of components of the device(s)/payment card as disclosed herein. In an aspect of an embodiment of the present invention, the term “module” may represent self-contained component system(s) and/or computer hardware and/or software. In another aspect of an embodiment of the present invention, the term “module” may represent component system(s) and/or computer hardware and/or software on a designated computer chip or separate computer chips. In yet another aspect of an embodiment of the present invention, the processor may be configured to perform tasks not undertaken by the module(s) disclosed herein. In a further aspect of an embodiment of the present invention, the modules may be component system(s) and/or computer hardware and/or software resident on one chip, component, separate components, a remote server, database, some or each of which (or all of which, in one aspect of an embodiment of the present invention) may be separate and distinct from the device, or any combination thereof. In one aspect of an embodiment of the present invention, the processor may be configured to coordinate, implement and/or assign tasks to, from and/or among the module(s). In a further aspect of an embodiment of the present invention, “module” may represent operational cooperation between system components. For instance, a module may comprise of one or more processors, memory, computer executable instructions (code) executable by the processor(s) and resident within memory location(s) etc. with each component being in communication with one or more other components in the module and each component working with the other component(s) to conduct the desired operation. In a further aspect of an embodiment of the present invention, module components may also, in an operational context, be components of other modules. These modules may be any one or more of: components of server(s)/processor(s) or may include server(s)/processor(s) which may perform a predefined set of basic operations in response to receiving a corresponding basic instruction selected from a predefined native instruction set of computer executable codes. The modules then may include a set of machine codes selected from the native instructions set of the server(s)/processor(s) to perform specific functions and/or operations. The native instructions set is a discrete code recognized by the hardware and/or software processor(s) and may be built into the hardware and/or software processor(s) and presents the way the system communicates with the hardware and/or software processor(s). In an aspect of an embodiment of the present invention, the native instructions set specify certain registers for arithmetic, addressing and/or control functions. In addition, the native instructions set can specify addressing modes which are utilized to interpret operands. Combination and/or permutations of the different native instructions may be done for more complex computer operations or functionality.

A further aspect of an embodiment of the present invention contemplates use of non-transitory computer program product which may include a computer usable medium having control logic/computer executable instructions stored on it for causing processor(s) and, in other aspects, sub-processors to perform all operations contemplated herein.

Aspect(s) of embodiment(s) of the present invention may make use of hardware and/or software processor(s) configured to perform a predefined set of basic operations in response to receiving a corresponding basic computer executable instruction selected from a predefined native instruction set of codes.

### DRAWING DESCRIPTIONS

FIG. 1A illustrates a block diagram showing components of a payment card with DNA processing and biometric authentication capability according to aspects of embodiments of the present invention.

FIG. 1B illustrates a front view of a payment card with DNA processing and biometric authentication capability according to aspects of embodiments of the present invention.

FIG. 1C illustrates a perspective view of a payment card with DNA processing and biometric authentication capability according to aspects of embodiments of the present invention.

FIG. 1D illustrates an internal view of a payment card with DNA processing and biometric authentication capability according to aspects of embodiments of the present invention.

FIG. 1E illustrates an interior view of a payment card with DNA processing and biometric authentication capability according to aspects of embodiments of the present invention.

FIG. 2 illustrates a process for manufacturing a payment card with DNA processing and biometric authentication capability according to aspects of embodiments of the present invention.

### DETAILED DESCRIPTION OF THE INVENTION

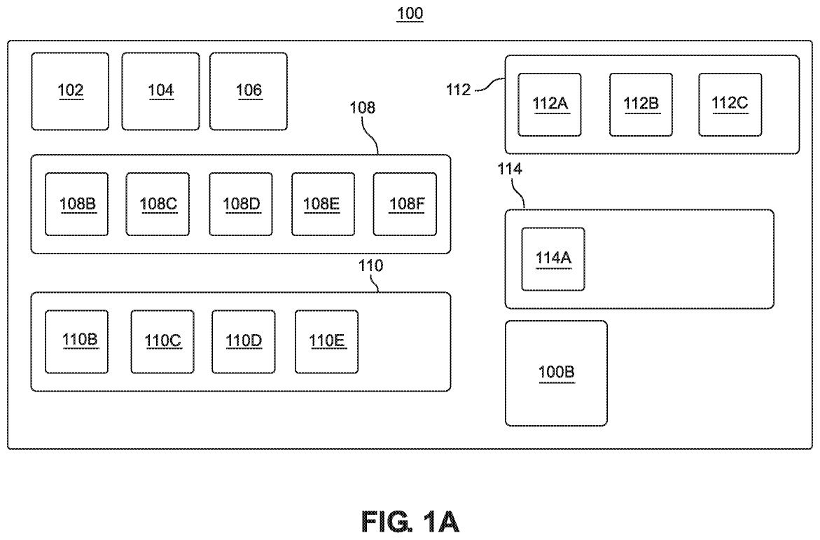

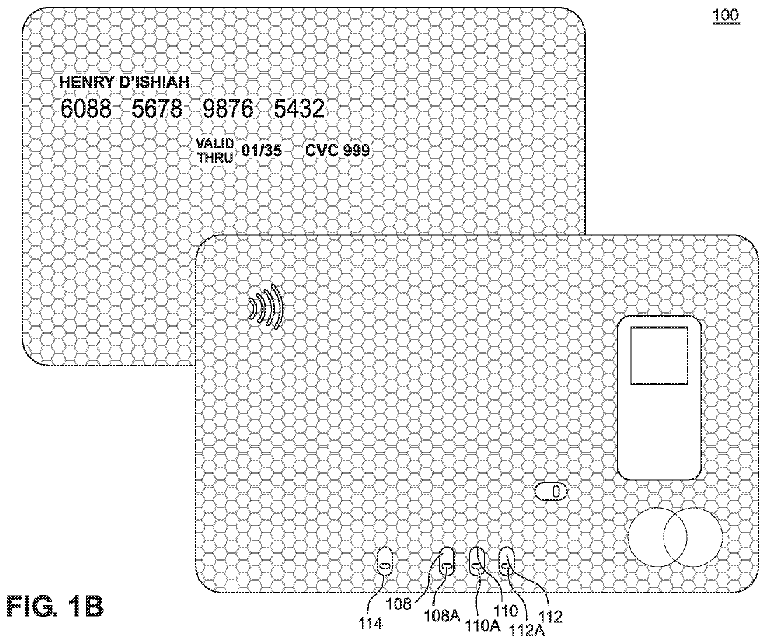

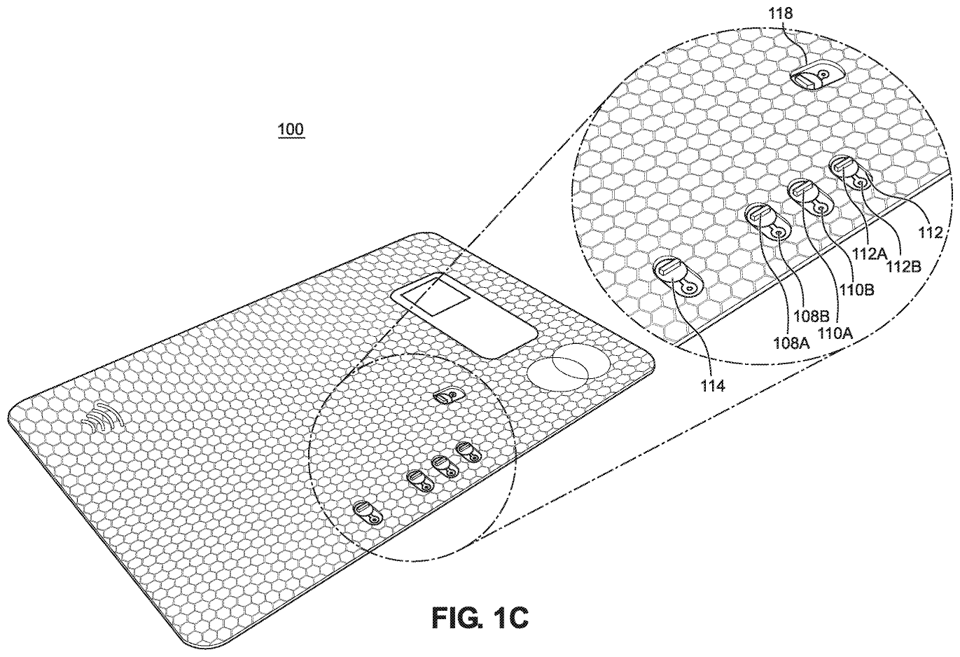

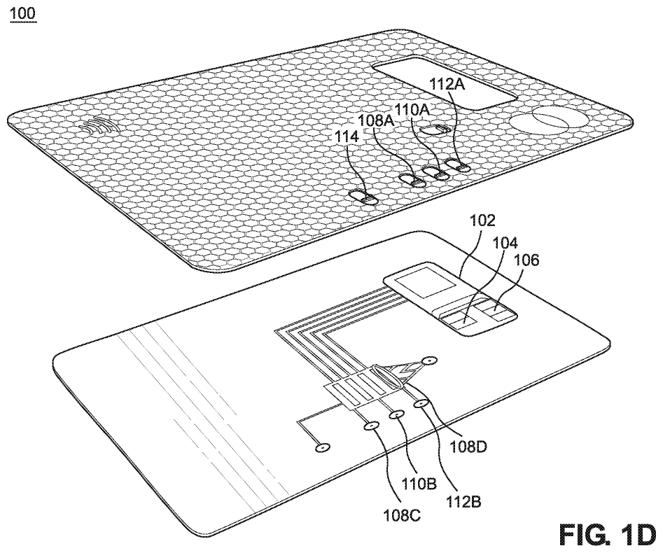

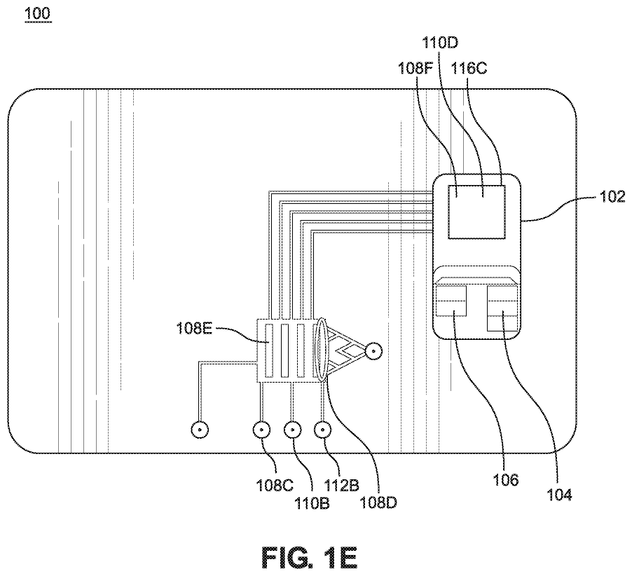

Referring now to FIGS. 1A through 1E, a payment card 100 configured for financial transaction operations, DNA processing and biometric authentication, is shown according to aspects of embodiments of the present invention. Payment card 100 may include microchip 102, which in turn, includes at least one main processor 104 configured to perform a predefined set of basic operations in response to receiving a corresponding basic computer executable instruction selected from a predefined native instruction set of codes. Microchip 102 may also include memory 106 for storing data related to operations of payment card 100. Payment card 100 may also include DNA processing module 108, biometric sensor module 110, and transceiver module 116.

In an aspect of an embodiment of the present invention, processor 104 pf payment card 100 may be in communication with any one or more of: memory 106, DNA processing module 108, biometric sensor module 110, and transceiver module 116 to coordinate and implement operations of each element of payment card 100.

In an aspect of an embodiment of the present invention, DNA processing module 108 may comprise of needle mechanism 108B, where needle mechanism 108B is configured to puncture a cardholder's skin to collect a minimal blood sample. Proximate to needle mechanism 108B is DNA collection area 108C where the blood sample is collected and transmitted to processing area 108D. Transmission may be implemented by way of osmotic action or any other methods known in the art to transmit samples up or down a gradient.

DNA processing module 108 may also comprise of DNA processing module cover 108A which is used to cover both needle mechanism 108B and DNA collection area 108C from contamination of tampering.

DNA processing module 108 may also comprise of processing area 108D, a chamber within DNA processing module 108 where DNA is extracted and analyzed. DNA processing module 108 may further comprise DNA analysis module 108E, which is configured to receive and process the collected blood sample for DNA analysis and identification confirmation of the cardholder.

In an aspect of an embodiment of the present invention, biometric sensor module 110 may comprise of a combination fingerprint scanner and vein reader 110B, where combination fingerprint scanner and vein reader 110B is configured to either read the cardholder's fingerprint or scan the cardholder's vein pattern (or do both). biometric sensor module 110 may also comprise of verification module 110C, which may be configured to compare the cardholder's biometric data and DNA results to confirm the cardholder's identity.

In an aspect of an embodiment of the present invention, payment card 100 may also include auxiliary module 112, which may also have a cover 112A and collection area 112B. Auxiliary module 112 may be used for the collection of any other personal identification other than DNA or biometric identification.

In an aspect of an embodiment of the present invention, payment card 100 may include universal cover control 114, which may be used to lock or unlock DNA processing module cover 108A, and biometric sensor module cover 110A. When cover control 114 is in the lock position, DNA processing module cover 108A, and biometric sensor module cover 110A remain locked. When cover control 114 is in the unlock position, DNA processing module cover 108A, and biometric sensor module cover 110A are then unlocked and available to receive samples from the cardholder.

In an aspect of an embodiment of the present invention, Transceiver Module 116 may comprise of radio transmitter 116A, receiver 116B, and at least one processor 116C configured to: secure a high-speed link between the DNA processing module 108 and the microchip 102 and integrate with existing payment networks for cardholder identity verification and transaction authorization.

In an aspect of an embodiment of the present invention, payment card 100 may also comprise of durable shielding 100A, where the shielding protects electronic components of payment card 100. Payment card 100 may also include Tamper proof feature or element 100B which is configured to protect against unauthorized access or alterations. In an aspect of an embodiment of the present invention, tamper proof feature 100B may be a module having a processor, memory, and computer readable code configured to analyze a cardholder's information, including biometric information to determine whether access to payment card 100 will be granted. Tamper proof feature 100B may be in communication with all other components or elements of payment card 100 to analyze all data inputs or select data inputs to determine whether access to payment card 100 should be granted. In an aspect of an embodiment of the present invention, payment card 100 may be made of biocompatible materials.

In an aspect of an embodiment of the present invention, DNA processing module 108 may additionally comprise of a DNA processing module sub-processor 108F for processing computer-implemented analyses and operations.

In an aspect of an embodiment of the present invention, biometric sensor module 110, may additionally comprise biometric sensor module 110 sub-processor 110D for processing computer-implemented analyses and operations related to the biometric analyses undertaken by biometric sensor module 110.

In an aspect of an embodiment of the present invention, payment card 100 may further comprise of backup identification module 118 for replacement operation when any one or more of: the biometric sensor module 110, DNA processing module 108 fails, where the backup identification module 118 may be in communication with any one or more of: microchip 102, biometric processing module 110, and DNA processing module 108; where backup identification module 118 comprises at least one processor 118A.

Aspects of embodiments of the present invention contemplate computer implemented methods, processes, computer program product (comprising a computer usable medium having computer executable instructions stored therein for causing a computer processor to perform certain operations), and devices directed to the full operation and functionality of payment card 100 as disclosed in this specification and the drawings being filed along with this specification.

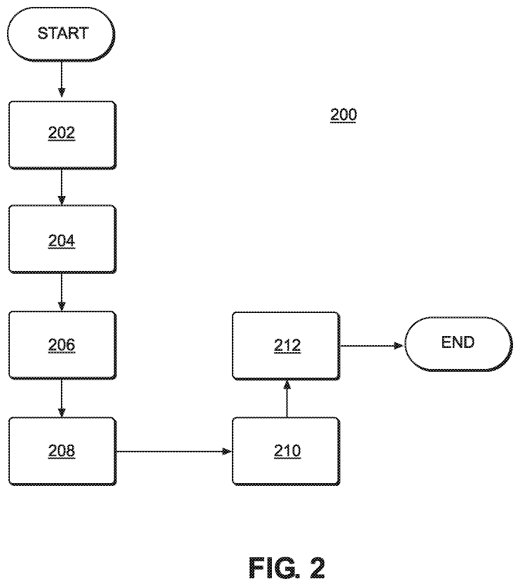

Referring now to FIG. 2, a method 200 for the manufacture of a payment card 100 configured to conduct DNA and biometric analysis, is shown according to aspects of embodiments of the present invention. In an aspect of an embodiment of the present invention, process 200 begins with design and prototyping step 202, where design and prototyping step 202 involves the computer-aided-design (CAD) modeling of: the card's design, design placement of needle mechanism 108B, design placement of a DNA processing module 108, design placement of a biometric sensor module 110, and design placement of at least one microchip 102.

Following design and prototyping step 202 is component fabrication step 204, where the component fabrication step comprises: microfabrication, which comprises manufacture of any one or more of: at least one microchip 102, DNA processing module 108, biometric sensor module 110, needle mechanism 108B, and injection molding, where the injection molding comprises production of a flexible substrate for housing components of payment card 100.

Following component fabrication step 204 is component integration step 206, where component integration step 206 comprises: integration of any one or more of: at least one microchip 102, DNA processing module 108, biometric sensor module 110, needle mechanism 108B, into payment card 100's substrate.

Following component integration step 206 is sealing and protection step 208, where sealing and protection step 208 comprises sealing, against environmental factors, payment card 100 following integration of any one or more of: at least one microchip 102, DNA processing module 108, biometric sensor module 110, needle mechanism 108B, into payment card 100's substrate.

Following sealing and protection step 208 is quality control step 210, where quality control step 210 comprises: subjecting payment card 100, after sealing and protection step 208, to rigorous quality testing.

Following quality control step 210 is packaging step 212, where packaging step 212 entails packaging of payment card 100 after quality control step 210.

In another aspect of an embodiment of the present invention, quality control step 210 may further comprise: testing to ensure proper functionality of DNA processing module 108, and biometric sensor module 110.

In another aspect of an embodiment of the present invention, quality control step 210 may further comprise testing to ensure compliance of needle mechanism 108B with safety standards.

In another aspect of an embodiment of the present invention, quality control step 210 may further comprise: testing to ensure reliability of payment processing features of payment card 100.

In another aspect of an embodiment of the present invention, packaging step 212 may further comprises: packaging of payment card 100 in sterile, tamper-proof/tamper/evident containers, with attendant use and safety warnings.

In another aspect of an embodiment of the present invention, microfabrication step 204 may further comprise: use of photolithography for creation of any one or more of: at least one microchip, DNA processing module 108, biometric sensor module 110, and needle mechanism 108B.

Although this present invention has been disclosed with reference to specific forms and embodiments, it will be evident that a great number of variations may be made without departing from the spirit and scope of the present invention. For example, steps may be reversed, equivalent elements may be substituted for those specifically disclosed and certain features of the present invention may be used independently of other features-all without departing from the present invention as outlined above, in the appended drawings and the claims presented below.

What is claimed is:

1. A payment card configured for financial transaction operations, DNA processing and biometric authentication, said payment card comprising:
a microchip comprising at least one processor configured to perform a predefined set of basic operations in response to receiving a corresponding basic computer executable instruction selected from a predefined native instruction set of codes;
memory;
a DNA processing module;
a biometric sensor module; and
a transceiver module.

2. The payment card of claim 1, where said at least one processor is in communication with any one or more of: said memory, said DNA processing module, said biometric sensor module, said transceiver module.

3. The payment card of claim 1, where said DNA processing module comprises of a needle mechanism, where said needle mechanism is configured to puncture a cardholder's skin to collect a minimal blood sample, a processing area, where said processing area is a chamber within said DNA processing module where DNA is extracted and analyzed, and a DNA analysis module, where said DNA analysis module is configured to receive and process the collected blood sample for DNA analysis and identification confirmation of said cardholder.

4. The payment card of claim 1, where said biometric sensor module comprises of: a combination fingerprint scanner and vein reader, where said combination fingerprint scanner and vein reader is configured to either read said cardholder's fingerprint or scan said cardholder's vein pattern, a verification module, where said verification module is configured to compare said cardholder's biometric data and DNA results to confirm identity.

5. The payment card of claim 1, where said transceiver module comprises of a radio transmitter, a receiver, and at least one processor configured to: secure a high-speed link between said DNA processing module and said microchip and integrate with existing payment networks for cardholder identity verification and transaction authorization.

6. The payment card of claim 1, where said payment card comprises: durable shielding, where said shielding protects electronic components of said payment card; and a tamper proof feature to protect against unauthorized access or alterations.

7. The payment card of claim 1, where said payment card is made of biocompatible materials.

8. The payment card of claim 1, where any one or more of: said DNA processing module, said biometric sensor module, comprises of a sub-processor for processing computer-implemented analyses and operations, where said sub-processor may be respectively resident on any one or more of: the DNA processing module, the biometric sensor module.

9. The payment card of claim 1, further comprising of a backup identification module for operation when any one or more of: said biometric sensor module, DNA processing module fails, where said backup identification module is in communication with any one or more of: said microchip, said biometric processing module, said DNA processing module; where said backup identification module comprises at least one processor.

10. A computer-implemented method for operation of a payment card configured for financial transaction operations, DNA processing and biometric authentication, said method comprising executing on at least one processor configured to perform a predefined set of basic operations in response to receiving a corresponding basic instruction selected from a predefined native instruction set of code, said at least one processor being part of a microchip of said payment card, the steps of:
operation of said at least one processor in conjunction with memory on said payment card;
operation of a DNA processing module;
operation of a biometric sensor module; and
operation of a transceiver module.

11. The computer implemented method of claim 10, further comprising operation of said at least one processor of said microchip in communication with any one or more of: said memory of said payment card, said DNA processing module, said biometric sensor module, said transceiver module.

12. The computer implemented method of claim 10, where operation of said DNA processing module comprises: collection of a minimal blood sample by a needle mechanism of said DNA processing module, extraction and analysis of DNA from said blood sample by a processing area of said DNA processing module, and identification confirmation by said DNA processing module.

13. The computer implemented method of claim 10, where operation of said biometric sensor module comprises: reading a cardholder's fingerprint, scanning said cardholder's vein pattern by a combination fingerprint scanner and vein reader of said biometric sensor module, and identity verification by a verification module of said biometric sensor module, where said verification module is configured to compare said cardholder's biometric data and DNA results to confirm identity.

14. The computer implemented method of claim 10, where operation of said transceiver module comprises: securing a high-speed link between said DNA processing module and said microchip, and integrating said payment card with existing payment networks for cardholder identity verification and transaction authorization, where said integration is done by at least one processor of said transceiver module using any one or more of: a radio transmitter, a receiver of said transceiver module.

15. The computer implemented method of claim 10, where operation of any one or more of: said DNA processing module, said biometric sensor module, comprises processing computer-implemented analyses and operations by a sub-processor respectively resident on any one or more of: said DNA processing module, said biometric sensor module.

16. The computer implemented method of claim 10, where operation of said microchip comprises: implementation and operation of encryption protocols to securely store and transmit sensitive data related to a cardholder's DNA and biometric information; implementation and operation of a feedback system that provides a cardholder with visual and/or auditory confirmation of successful identity verification; and implementation and operation of a digital tamper proof feature to protect against unauthorized access and/or data alterations.

17. The computer implemented method of claim 10, where operation of said payment card comprises: operation of a backup identification module for operation when any one or more of: said biometric sensor module, DNA processing module fails, where said backup identification module is in communication with any one or more of: said microchip, said biometric processing module, said DNA processing module; where said backup identification module comprises at least one processor.

18. A computer program product comprising a non-transitory computer readable medium having control logic stored therein for causing one or more computer processors, resident on a microchip, and configured to perform a predefined set of basic operations in response to receiving a corresponding basic instruction selected from a predefined native instruction set of code to enable operation of a payment card, the control logic comprising computer readable code for:
operation of said at least one processor in conjunction with memory on said payment card;
operation of a DNA processing module;
operation of a biometric sensor module; and
operation of a transceiver module.

19. The computer program product of claim 18, further comprising computer code for operation of said at least one processor of said microchip in communication with any one or more of: memory of said payment card, said DNA processing module, said biometric sensor module, said transceiver module.

20. The computer program product of claim 18, where computer code for operation of said DNA processing module comprises: computer code for collection of a minimal blood sample by a needle mechanism of said DNA processing module, computer code for extraction and analysis of DNA from said blood sample by a processing area of said DNA processing module, and computer code for identification confirmation by said DNA processing module.

21. The computer program product of claim 18, where computer code for operation of said biometric sensor module comprises: computer code for reading a cardholder's fingerprint, scanning said cardholder's vein pattern by a combination fingerprint scanner and vein reader of said biometric sensor module, and computer code for identity verification by a verification module of said biometric sensor module, where operation of said verification module comprises computer code configured to compare said cardholder's biometric data and DNA results to confirm identity.

22. The computer program product of claim 18, where computer code for operation of said transceiver module comprises: computer code for securing a high-speed link between said DNA processing module and said microchip, computer code for integrating said payment card with existing payment networks for cardholder identity verification and computer code for transaction authorization, where said integration is done by at least one processor of said transceiver module using any one or more of: a radio transmitter, a receiver of said transceiver module.

23. The computer program product of claim 18, where computer code for operation of any one or more of: said DNA processing module, said biometric sensor module, comprises computer code for processing computer-implemented analyses and operations by a sub-processor respectively resident on any one or more of: said DNA processing module, said biometric sensor module.

24. The computer program product of claim 18, where computer code for operation of said microchip comprises: computer code for implementation and operation of encryption protocols to securely store and transmit sensitive data related to a cardholder's DNA and biometric information; computer code for implementation and operation of a feedback system that provides a cardholder with visual and/or auditory confirmation of successful identity verification; and computer code for implementation and operation of a digital tamper proof feature to protect against unauthorized access and/or data alterations.

25. The computer program product of claim 18, where computer code for operation of said payment card comprises: computer code for operation of a backup identification module for operation when any one or more of: said biometric sensor module, DNA processing module fails, where said backup identification module is in communication with any one or more of: said microchip, said biometric processing module, said DNA processing module; where said backup identification module comprises at least one processor.

26. A method for the manufacture of a payment card configured to conduct DNA and biometric analysis, the method comprising:
a design and prototyping step, where said design and prototyping step comprises, CAD modeling of: said card's design, design placement of a needle mechanism, design placement of a DNA processing module, design placement of a biometric sensor module, design placement of at least one microchip;
a component fabrication step, where said component fabrication step comprises: microfabrication, which comprises manufacture of any one or more of: said at least one microchip, said DNA processing module, said biometric sensor module, said needle mechanism, and injection molding, where said injection molding comprises production of a flexible substrate for housing components of said payment card;
a component integration step, where said component integration step comprises: integration of any one or more of: said at least one microchip, said DNA processing module, said biometric sensor module, said needle mechanism, into said substrate;
a sealing and protection step, where said sealing and protection step comprises sealing, against environmental factors, said payment card following integration of any one or more of: said at least one microchip, said DNA processing module, said biometric sensor module, said needle mechanism, into said substrate;
a quality control step, where said quality control step comprises: subjecting said payment card, after said sealing and protection step, to rigorous quality testing; and
a packaging step, where said packaging step entails packaging of said payment card after said quality control step.

27. The method of claim 26, where said quality control step further comprises: testing to ensure proper functionality of said DNA processing module, and said biometric sensor module.

28. The method of claim 26, where said quality control step further comprises: testing to ensure compliance of said needle mechanism with safety standards.

29. The method of claim 26, where said quality control step further comprises: testing to ensure reliability of payment processing features of said payment card.

30. The method of claim 26, where said packaging step further comprises: packaging of said payment card in sterile, tamper-proof/tamper/evident containers, with attendant use and safety warnings.

31. The method of claim 26, where said microfabrication step further comprises: use of photolithography for creation of any one or more of: said at least one microchip, said DNA processing module, said biometric sensor module, said needle mechanism.
